(19) United States
(12) Patent Application Publication
(10) Pub. No.: US 2021/0137659 A1
(43) Pub. Date: May 13, 2021

(54) DENTAL HYGIENE DEVICE

(71) Applicant: Jasmine Othman, Redondo Beach, CA (US)

(72) Inventor: Jasmine Othman, Redondo Beach, CA (US)

(21) Appl. No.: 16/681,550

(22) Filed: Nov. 12, 2019

(51) Int. Cl. A61C 15/04

(52) U.S. Cl. CPC A61C 15/046

(57) ABSTRACT

A dental hygiene device for flossing teeth of a user includes a tube, which has a first end that is open and configured for insertion of a finger of a user to removably couple the tube to the finger. A pair of arms is coupled to and extends from the tube. A line is coupled to and extends between the arms distal from the tube. The line is configured for insertion between teeth of the user to floss the teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hygiene devices and more particularly pertains to a new hygiene device for flossing teeth of a user.

### (2) Description of Related Art Including Information Disclosed Under 37 CFR 1.97 and 1.98

The prior art relates to hygiene devices.

### BRIEF SUMMARY OF THE INVENTION

An embodiment of the disclosure meets the needs presented above by generally comprising a tube, which has a first end that is open and configured for insertion of a finger of a user to removably couple the tube to the finger. A pair of arms is coupled to and extends from the tube. A line is coupled to and extends between the arms distal from the tube. The line is configured for insertion between teeth of the user to floss the teeth.

In another embodiment, the device comprises set of flossing modules and a pair of slots. Each slot extends into the second terminus of a respective arm. Each flossing module comprises a string, which is selectively insertable into the pair of slots, and a pair of knobs, each of which is coupled to a respective opposing end of the string so that each knob is positioned in abutment to an outer face of a respective arm. The knobs retain the string between the pair of arms so that the string is tensioned between the pair of arms.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a dental hygiene device according to an embodiment of the disclosure.

FIG. 2 is a bottom view of an embodiment of the disclosure.

FIG. 3 is a side view of an embodiment of the disclosure.

FIG. 4 is an in-use view of an embodiment of the disclosure.

FIG. 5 is an isometric perspective view of an alternative embodiment of the disclosure.

### DETAILED DESCRIPTION OF THE INVENTION

With reference now to the drawings, and in particular to FIGS. 1 through 5 thereof, a new hygiene device embodying the principles and concepts of an embodiment of the disclosure and generally designated by the reference numeral 10 will be described.

As best illustrated in FIGS. 1 through 5, the dental hygiene device 10 generally comprises a tube 12, which has a first end 14 that is open and configured for insertion of a finger of a user to removably couple the tube 12 to the finger. The tube 12 has a second end 16 that may be open so that the tube 12 is selectively slidable upon the finger of the user. The tube 12 is configured to slide upon the finger to a point where the finger is substantially circumferentially complementary to the tube 12 so that the tube 12 is removably coupled to the finger. The tube 12 comprises at least one of silicone, rubber, and plastic so that the tube 12 is resiliently flexible and configured to substantially form to a shape of the finger of the user.

A pair of arms 18 is coupled to and extends from the tube 12. The arms 18 extend from the same quadrant 20, or proximate to the same quadrant 20, of the tube 12 when the tube 12 is viewed longitudinally, as shown in FIG. 2. Each arm 18 has a first terminus 22 that is coupled to a sidewall 24 of the tube 12 and a second terminus 26 that is distal from the sidewall 24. The first terminus 22 is dimensionally wider than the second terminus 26 so that the arm 18 is substantially triangularly shaped. The second terminus 26 is arcuate and thus is configured to slide on teeth and gums of the user rather than to poke the gums.

As shown in FIG. 2, the arms 18 extend arcuately from the sidewall 24 so that the first termini 22 are separated less than the second termini 26. The arms 18 comprise at least one of plastic and metal.

A line 28 is coupled to and extends between the arms 18 distal from the tube 12. The line 28 is configured for insertion between teeth of the user to floss the teeth. It is anticipated that the device 10 of this embodiment would be used for a single session of flossing and then discarded. However, this embodiment also anticipates the device 10 being constructed such that the device 10 is at least one of cleanable and sterilizable so that the device 10 can be used for multiple sessions of flossing.

In another embodiment of the invention, the device comprises set of flossing modules 30 and a pair of slots 32. Each slot 32 extends into the second terminus 26 of a respective arm 18. Each flossing module 30 comprises a string 34, which is selectively insertable into the pair of slots 32, and a pair of knobs 36, each of which is coupled to a respective opposing end 38 of the string 34 so that each knob 36 is positioned in abutment to an outer face 40 of a respective arm 18. The knobs 36 retain the string 34 between the pair of arms 18 so that the string 34 is tensioned between the pair of arms 18.

The knobs 36 may be substantially spherically shaped so that the knobs 36 slide on the gums of the user, or may be alternatively shaped, such as ovally shaped, hemispherically shaped, disc shaped, and the like.

The device 10 of this embodiment also may comprise a tray 42 that is configured to stow the set of flossing modules 30. The tray 42 comprises a block 44 that is substantially rectangularly box shaped. A set of recesses 46 extends into an upper face 48 of the block 44. Each recess 46 extends between opposing sides 50 of the block 44 and the set of recesses 46 extends from proximate to opposing endpoints 52 of the block 44. The opposing sides 50 of the block 44 are separated so that each string 34 is selectively insertable into a respective recess 46 with each knob 36 positioned proximate to a respective opposing side 50 of the block 44. A respective arm 18 is selectively insertable between the knob 36 and the respective opposing side 50 of the block 44 to insert the string 34 to the pair of slots 32 to removably couple the string 34 to the pair of arms 18.

The set of recesses 46 comprises from four to twelve recesses 46. The set of recesses 46 may comprise from six to eight recesses 46. As shown in FIG. 5, the set of recesses 46 comprises seven recesses 46. As such, there would be seven flossing modules 30 available to a user, each of which might be used once, thus providing for seven flossing sessions. The seven flossing modules 30 thus would provide a weekly supply for a user who flosses once per day. However, this embodiment also anticipates the flossing module 30 being constructed such that the flossing module 30 is at least one of cleanable and sterilizable so that the flossing module 30 can be used for multiple sessions of flossing.

In use, the user inserts a finger into the tube 12 and then manipulates the finger so that the line 28 is inserted between the teeth of the user to floss the teeth.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A dental hygiene device comprising:
a tube having a first end, the first end being open wherein the first end is configured for inserting a finger of a user for removably coupling the tube to the finger;
a pair of arms coupled to and extending from the tube; and
a line coupled to and extending between the arms distal from the tube wherein the line is configured for inserting between teeth of the user for flossing the teeth.

2. The device of claim 1, further including the tube having a second end, the second end being open such that the tube is selectively slidable upon the finger of the user wherein the tube is configured for sliding upon the finger to a point wherein the finger is substantially circumferentially complementary to the tube such that the tube is removably coupled to the finger.

3. The device of claim 1, further including the tube comprising at least one of silicone, rubber, and plastic such that the tube is resiliently flexible wherein the tube is configured for substantially forming to a shape of the finger of the user.

4. The device of claim 1, further including the arms extending from the same quadrant, or proximate to the same quadrant, of the tube when the tube is viewed longitudinally.

5. The device of claim 4, further including each arm having a first terminus coupled to a sidewall of the tube and a second terminus distal from the sidewall, the first terminus being dimensionally wider than the second terminus such that the arm is substantially triangularly shaped.

6. The device of claim 5, further including the second terminus being arcuate wherein the second terminus is configured for sliding on the teeth and gums of the user.

7. The device of claim 5, further including the arms extending arcuately from the sidewall such that the first termini are separated less than the second termini.

8. The device of claim 1, further including the arms comprising at least one of plastic and metal.

9. The device of claim 1, further comprising:
a pair of slots, each slot extending into a second terminus of a respective arm; and
a set of flossing modules, each flossing module comprising:
a string selectively insertable into the pair of slots, and
a pair of knobs, each knob being coupled to a respective opposing end of the string such that each knob is positioned in abutment to an outer face of a respective arm for retaining the string between the pair of arms and such that the string is tensioned between the pair of arms.

10. The device of claim 9, further including the knobs being substantially spherically shaped.

11. The device of claim 9, further including a tray configured for stowing the set of flossing modules.

12. The device of claim 11, further including the tray comprising:
a block, the block being substantially rectangularly box shaped; and
a set of recesses extending into an upper face of the block, each recess extending between opposing sides of the block such that the set of recesses extends from proximate to opposing endpoints of the block, the opposing sides of the block being separated such that each string is selectively insertable into a respective recess with each knob positioned proximate to a respective opposing side of the block such that a respective arm is selectively insertable between the knob and the respective opposing side of the block for inserting the string to the pair of slots for removably coupling the string to the pair of arms.

13. The device of claim 12, further including the set of recesses comprising from four to twelve recesses.

14. The device of claim 13, further including the set of recesses comprising from six to eight recesses.

15. The device of claim 14, further including the set of recesses comprising seven recesses.

16. A dental hygiene device comprising:
a tube having a first end, the first end being open wherein the first end is configured for inserting a finger of a user for removably coupling the tube to the finger, the tube having a second end, the second end being open such that the tube is selectively slidable upon the finger of the user wherein the tube is configured for sliding upon the finger to a point wherein the finger is substantially circumferentially complementary to the tube such that the tube is removably coupled to the finger, the tube comprising at least one of silicone, rubber, and plastic such that the tube is resiliently flexible wherein the tube is configured for substantially forming to a shape of the finger of the user;
a pair of arms coupled to and extending from the tube, the arms extending from the same quadrant, or proximate to the same quadrant, of the tube when the tube is viewed longitudinally, each arm having a first terminus coupled to a sidewall of the tube and a second terminus distal from the sidewall, the first terminus being dimensionally wider than the second terminus such that the arm is substantially triangularly shaped, the second terminus being arcuate wherein the second terminus is configured for sliding on teeth and gums of the user, the arms extending arcuately from the sidewall such that the first termini are separated less than the second termini, the arms comprising at least one of plastic and metal; and
a line coupled to and extending between the arms distal from the tube wherein the line is configured for inserting between the teeth of the user for flossing the teeth.

17. The device of claim 16, further comprising:
a pair of slots, each slot extending into the second terminus of a respective arm;
a set of flossing modules, each flossing module comprising:
a string selectively insertable into the pair of slots, and
a pair of knobs, each knob being coupled to a respective opposing end of the string such that each knob is positioned in abutment to an outer face of a respective arm for retaining the string between the pair of arms and such that the string is tensioned between the pair of arms, the knobs being substantially spherically shaped; and
a tray configured for stowing the set of flossing modules, the tray comprising:
a block, the block being substantially rectangularly box shaped, and
a set of recesses extending into an upper face of the block, each recess extending between opposing sides of the block such that the set of recesses extends from proximate to opposing endpoints of the block, the opposing sides of the block being separated such that each string is selectively insertable into a respective recess with each knob positioned proximate to a respective opposing side of the block such that a respective arm is selectively insertable between the knob and the respective opposing side of the block for inserting the string to the pair of slots for removably coupling the string to the pair of arms, the set of recesses comprising from four to twelve recesses, the set of recesses comprising from six to eight recesses, the set of recesses comprising seven recesses.
